(19) United States
(12) Patent Application Publication
(10) Pub. No.: US 2014/0033677 A1
(43) Pub. Date: Feb. 6, 2014

(54) EXTERNALLY POWERED VEHICLE PROPULSION SYSTEM

(71) Applicant: Dmitriy Tseliakhovich, Broomfield, CO (US)

(72) Inventor: Dmitriy Tseliakhovich, Broomfield, CO (US)

(73) Assignee: ESCAPE DYNAMICS, INC., Broomfield, CO (US)

(21) Appl. No.: 13/958,134

(22) Filed: Aug. 2, 2013

Related U.S. Application Data
(60) Provisional application No. 61/678,840, filed on Aug. 2, 2012.

(51) Int. Cl. F03H 1/00

(52) U.S. Cl. CPC F03H 1/0093
USPC 60/202

(57) ABSTRACT

A vehicle propulsion system comprises a propellant source, a microwave energy source; an ionizer, a heater, and a propellant accelerator. The ionizer is configured for receiving propellant and for also receiving microwave energy from the microwave energy source so as to produce ionized propellant. The heater comprises a heater shell that defines a plasma heating cavity and is configured for receiving the ionized propellant from the ionizer. The heater shell is configured to transmit microwave energy received from the microwave energy source to the ionized propellant in the plasma heating cavity and to thereby facilitate absorption of microwave energy by the ionized propellant to produce heated ionized propellant. The propellant accelerator is configured for receiving the heated ionized propellant from the heater, accelerating the heated ionized propellant to produce accelerated propellant, and expelling the accelerated propellant in a desired direction to impose a reaction force (i.e., thrust) upon the vehicle.

### CROSS-REFERENCES TO RELATED APPLICATIONS

This patent application claims priority to U.S. Provisional Patent Application Ser. No. 61/678,840 filed Aug. 2, 2012, which is incorporated herein by reference in its entirety.

### FIELD OF THE INVENTION

Exemplary embodiments of the invention relate generally to the field of propulsion systems and, more particularly, to propulsion systems relying on an external source of energy to facilitate addition of energy to the propellant, which propellant may be expelled so as to produce thrust for propulsion of a vehicle and/or may be expanded in a mechanical apparatus so as to produce useful work, particularly for acceleration and/or control of a vehicle and for driving mechanical systems relating thereto.

### BACKGROUND

A vehicle may be propelled by an engine that imposes a reaction force (i.e., thrust) by expulsion of matter in a desired direction. Thrust is related to momentum of the expelled matter, which depends upon both the velocity at which matter is expelled and the mass of the expelled matter. In a propulsion system, expelled matter may comprise both ionized gas particles and neutral gas particles (i.e., plasma). In some propulsion systems (e.g., rockets), the matter to be expelled is carried on-board the vehicle. In other propulsion systems, such as air-breathing propulsion systems used in aircraft or watercraft, matter to be expelled may be acquired from an off-board source.

To accelerate the matter for expulsion from the propulsion system requires input of energy. In a plasma engine, an on-board source of energy may provide for both ionization of an on-board propellant and acceleration of the plasma particles. One limitation of plasma engines is that they may require energy storage and conversion equipment to be carried on-board the vehicle. Such equipment may be heavy and prone to failure. Weight associated with the energy conversion equipment in existing plasma engines renders their thrust-to-weight ratios insufficient to enable their practical use in space launch and suborbital flight applications. These issues have thus far limited the use of plasma engines in space launch, suborbital launch, and space propulsion applications.

To address the weight issue in plasma engines, and to improve their practicability for space launch, suborbital launch, and space propulsion applications, it has been proposed to transmit energy from an off-board source to an on-board propulsion system in the form of an electromagnetic beam. Off-board sources that have been proposed include remote facilities such as a ground-based emitter or array of emitters, a space-based emitter or array of emitters, and a beaming facility located on a ship or naval platform. In the article Beamed Microwave Power And Its Application To Space, IEEE Transactions on Microwave Theory and Techniques Vol. 40 No. 6 (1992), William C. Brown discusses opportunities for external propulsion and the use of microwave wireless power transfer for space launch, space propulsion and aircraft propulsion applications. A more recent summary of external propulsion is provided in an article by Dr. James Benford, Space applications of high-power microwaves, IEEE Transactions on plasma science, Vol. 36, (2008).

U.S. Pat. No. 6,993,898 B2 issued to Dr. Kevin Parkin describes a microwave heat-exchange thruster wherein external microwaves originating from a ground-based or on-board source provide heat to a microwave absorbent heat exchanger. In Dr. Parkin's thruster, heat is transferred from the heat exchanger to a propellant, which is accelerated as it expands through a nozzle to produce thrust. Unfortunately, in Dr. Parkin's thruster engine, energy transfer to the propellant matter is generally limited by the temperature-handling capabilities of the heat exchanger. This temperature limitation translates directly to a limitation on the efficiency of the engine such that increases in efficiency require advances in both microwave absorbing capabilities, and temperature and pressure handling capabilities, of the materials.

Accordingly, it is desirable to have improved systems and methods for transferring energy from an external source to a stream of propellant matter in a propulsion system.

### SUMMARY

In one aspect of the invention, an exemplary vehicle propulsion system comprises a propellant source, a microwave energy source, an ionizer, a heater, and a propellant accelerator. The ionizer defines an ionizing chamber and is configured for receiving propellant from the propellant source into the ionizing chamber. The ionizer is also configured for receiving microwave energy from the microwave energy source so as to ionize the propellant to produce ionized propellant. The heater comprises a heater shell that defines a plasma heating cavity and is configured for receiving the ionized propellant from the ionizer into the plasma heating cavity. The heater shell is configured to transmit microwave energy received from the microwave energy source to the ionized propellant in the plasma heating cavity and to thereby facilitate absorption of microwave energy by the ionized propellant in the heating cavity to produce heated ionized propellant. The propellant accelerator is configured for receiving the heated ionized propellant from the heater, accelerating the heated ionized propellant to produce accelerated propellant, and expelling the accelerated propellant in a desired direction to impose a reaction force upon the vehicle.

In another aspect, an exemplary method for providing a reaction force to a vehicle comprises providing a propellant to an ionizer and providing microwave energy to the ionizer so as to ionize the propellant in the ionizer, thereby producing ionized propellant. The ionized propellant is transferred from the ionizer to a heater, and microwave energy is provided to the heater so as to transfer the energy directly to the ionized propellant, thereby producing heated ionized propellant. The heated ionized propellant is accelerated, thereby producing accelerated propellant, which is expelling in a desired direction to impose a reaction force upon the vehicle.

The above features and advantages, and other features and advantages of the invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a diagrammatic view of an exemplary system comprising an external microwave source and a thruster;

FIG. 2 shows an exemplary system comprising an external microwave source and thruster;

FIG. 3 is a simplified schematic diagram showing an exemplary propulsion system including a ground-based power beaming infrastructure, an ascent trajectory and a launch vehicle with a plasma thruster;

FIG. 4 is a drawing of an exemplary launch vehicle comprising an externally powered plasma thruster; and

FIG. 5 is a drawing of another exemplary launch vehicle comprising an externally powered plasma thruster.

It is expressly understood that the invention as defined by the claims may be broader than the embodiments illustrated in the Figures and described in the detailed description section below.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

In an exemplary embodiment, an externally powered vehicle propulsion system receives electromagnetic energy from an external source and facilitates the application of some or all of that energy to a propellant carried by a vehicle. The propellant absorbs some or all of the received energy, and is accelerated before being expelled from the vehicle so as to provide energy for propulsion or control of the vehicle. Acceleration of the propellant may be accomplished via means suitable for rocket propulsion, such as via a plasma thruster. In an exemplary embodiment, some or all of the propellant may alternatively be expanded in a mechanical apparatus (e.g., a turbine disposed for driving a shaft and other coupled machinery such as a compressor and/or a generator or alternator), so as to produce useful work, particularly for driving mechanical systems relating to the propulsion system of the vehicle (e.g., a turbo-pump for pumping propellant).

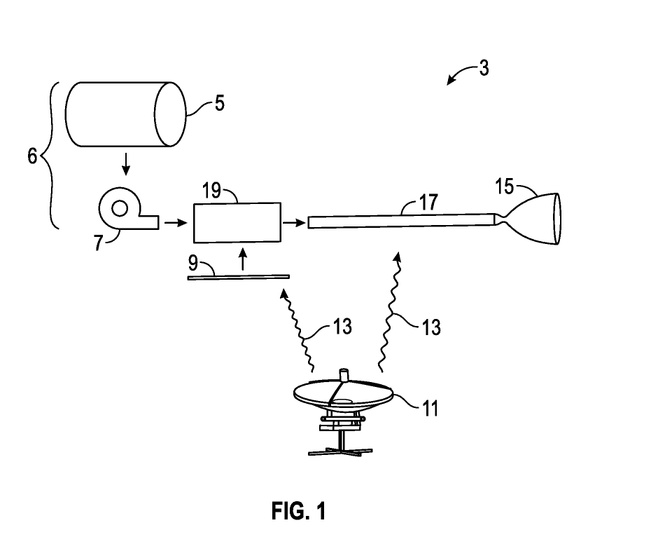

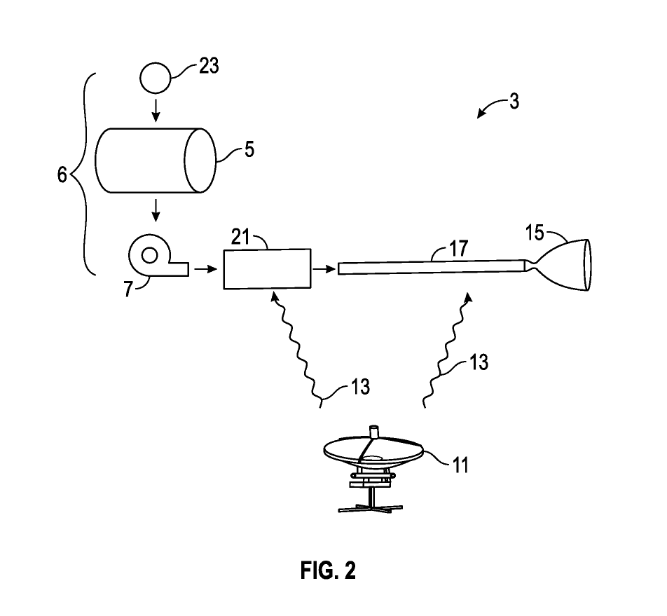

FIG. 1 is a diagrammatic view of an exemplary externally powered vehicle propulsion system 3. As shown in FIG. 1, an external microwave energy source 11 (i.e., microwave emitter) provides a microwave energy beam 13 for receipt and use by one or more components of the vehicle propulsion system 3. It should be appreciated that the microwave energy beam 13 may comprise one or more beams of microwave energy, and each individual beam may be transmitted continuously or pulsed intermittently, so as to produce, in the aggregate, a desired transmission of microwave energy. The microwave energy source 11 is disposed and configured to direct the microwave energy beam 13 toward the receiving components, which may include a rectifying antenna 9 (i.e., a rectenna or a directional waveguide), a plasma generator 21 (FIG. 2), and/or a propellant heater 17. In an exemplary embodiment, the microwave energy source 11 (i.e., microwave emitter) is configured to transmit electromagnetic energy at frequencies between approximately 500 MHz and approximately 300 GHz.

The microwave energy source 11 (i.e., the external source of electromagnetic energy) may include a single aperture antenna or a phased-array facility comprising a plurality of individual antennas serving as sources of electromagnetic energy and may be disposed in a variety of fixed or mobile locations. For example, the microwave energy source 11 may be ground-based (e.g., a fixed or mobile source disposed on land), sea-based (e.g., a fixed or floating platform disposed in or on a body of water, similar to an oil production platform, or mobile watercraft, such as a barge or an aircraft carrier), flight-based (e.g., carried on-board an aircraft, such as a fixed-wing aircraft, a balloon, or a blimp), satellite-based (e.g., carried aboard a vehicle orbiting the earth, the moon, or another body), or space-based (i.e., carried aboard a vehicle outside the orbit of any single body or set of bodies.

In an exemplary embodiment, a microwave energy source 11 comprises a microwave emitter (e.g., a gyrotron, magnetron, relativistic magnetron, klystron, or TWT or any other microwave emitting device), a waveguide system, a single aperture antenna or phased array of antennas. The microwave energy source 11 may also comprise a tracking mechanism configured for rotating, and thereby aiming, the antenna or array of antennas to facilitate pointing of the microwave energy beam 13 toward the receiving components. The microwave energy source 11 may also comprise a phase tuner configured to provide fine-adjustments to the phasing of microwave emitters of the microwave energy source 11 so as to achieve more precise adjustments to the aiming of the microwave energy beam 13. Energy necessary to power the microwave energy source 11 may be provided by an established electric grid or by a dedicated energy generating power plant. In some applications, it may be advantageous for the necessary energy to be collected (e.g., via solar panels) and either stored for subsequent release as a microwave energy beam 13 or otherwise manipulated so as to be concurrently transmitted as a microwave energy beam 13.

As shown in FIG. 1, in an exemplary embodiment, an externally powered vehicle propulsion system 3 includes a propellant storage tank 5 that is in fluid communication with a pump 7. The pump 7 is configured for motivating the propellant to flow through the system 3 and may comprise any type of pumping apparatus suitable for that purpose, including a turbopump. In an exemplary embodiment, the pump 7 is powered by a source of stored energy, such as a battery (not shown), or by a turbine (not shown) that is driven by expansion of propellant from the propellant storage tank 5 following the propellant's absorption of energy from the microwave energy beam 13. Thus, the propellant storage tank 5 and the turbopump 7 cooperate to provide a source of propellant (i.e., a propellant source 6) for the externally powered vehicle propulsion system 3.

In an exemplary embodiment, the propellant source 6 is configured to supply propellant comprising hydrogen. The propellant source 6 may also be configured to supply propellant comprising an inert gas. The propellant source 6 may comprise a source of propellant on-board the vehicle, a source of propellant external to the vehicle, or a combination of sources of propellant both on-board the vehicle and external to the vehicle. A propellant source 6 may be configured to supply propellant comprising gaseous matter from outside the vehicle, such as ambient atmosphere.

Pressure in the propellant storage tank 5 may be maintained at desired levels (e.g., at a constant pressure; at increased pressures, such as when it may be desired to increase a flow rate of propellant; or at decreased pressures, such as when it may be desired to decrease a flow rate of propellant) by using a pressure stabilization tank 23 (FIG. 2) or via controlled heating of the tank by allowing a controlled quantity of heat to enter the tank, through the insulation or via another controlled path. It should be appreciated that the pressure stabilization tank 23 may be disposed within the propellant storage tank 5 (i.e., as a bladder whose internal volume may be increased or decreased so as to change the volume available within the propellant storage tank 5 for storing the propellant) or may be disposed externally to the pressure stabilization tank 23 so as to provide a means for injecting matter into, or receiving matter from, the pressure stabilization tank 23 so as to achieve a desired level of pressurization of the propellant within the propellant storage tank 5.

It should be appreciated that suitable controls mechanisms, including one or more fluidic throttle valves and suitable instrumentation, may be disposed in the path of the propellant and that a suitable control system (e.g., a digital electronic control system comprising a processor coupled to a memory storage device, on which memory storage device instructions may be stored, with such instructions being configured for providing for the effective control, e.g., via actuation of the valves, of the flow of propellant in response to feedback received from system instrumentation or other commands received by the control system) may also be disposed and coupled to the fluidic throttle valves and the instrumentation so as to facilitate effective control over the flow rate and pressure of the propellant as it is supplied to the downstream components of the vehicle propulsion system 3.

In an exemplary embodiment, an ionizer 19 is disposed in fluid communication with the turbopump 7 and/or other propellant sources. The ionizer 19 is configured for receiving a stream of propellant and ionizing the stream of propellant to produce a stream (i.e., flow) of ionized propellant. In one embodiment, as shown in FIG. 1, the ionizer 19 is configured to cooperate with the rectifying antenna 9 so as to ionize propellant passing through, or contained within, an internal chamber (i.e., an ionizing chamber) defined by the ionizer 19. The ionizing chamber, and thus the ionizer 19, is in fluid communication with the turbopump 7 and/or another source of propellant and is configured for receiving, into the ionizing chamber, a flow of propellant at suitable pressures and temperatures from the turbopump 7 and/or from any other suitable source of propellant. Accordingly, the rectifying antenna 9 is configured to receive microwave energy from the microwave energy source 11 and to use the microwave energy, in cooperation with the ionizer 19, to ionize the propellant, whereby the ionizer 19 is enabled to produce a stream of ionized propellant.

In an alternative embodiment, as shown in FIG. 2, the function of the ionizer is served by a plasma generator 21 that is configured to receive the flow of propellant, to receive microwave energy from the microwave energy source 11, and to use the microwave energy to ionize propellant passing through, or contained within, an internal chamber defined by the plasma generator 21. Similar to the embodiment shown in FIG. 1, the plasma generator 21 is configured to ionize propellant passing through, or contained within, the plasma generation chamber.

It should be appreciated that the function of the ionizer 19 may be served by a number of systems and methods suitable for ionizing a stream of propellant. For example, the ionizer 19 (i.e., ionization chamber) may use energy provided by a microwave beam either directly, as illustrated in the embodiment of FIG. 2, or through the use of a dc current, which is generated by a rectifying antenna 9 proximate the ionization chamber.

It should be appreciated that the ionizer may include a built-in directional waveguide for ionizing the propellant in the ionizing chamber directly, without the use of the rectifying antenna 9. Whether the vehicle propulsion system 3 includes an ionizer 19 coupled with a rectifying antenna 9 (FIG. 1) or a plasma generator 21 (FIG. 2), the flow of ionized propellant is to be delivered from the ionizer 19 (FIG. 1) or the plasma generator 21 (FIG. 2) to a propellant heater 17. Thus, in the embodiment of FIG. 1, the ionizer 19 is in fluid communication with the propellant heater 17, and in the embodiment of FIG. 2, the plasma generator 21 is in fluid communication with the propellant heater 17.

In an exemplary embodiment, as shown in FIG. 1 and FIG. 2, the propellant heater 17 comprises a heater shell that defines a plasma heating cavity disposed within the heater shell. The propellant heater 17 is configured for receiving the ionized propellant from the ionizer 19 into the plasma heating cavity. The propellant heater 17 is also configured to receive the microwave energy beam 13, which the microwave energy source 11 transmits directly to the propellant heater 17. At least a portion of the heater shell is configured to transmit microwave energy received from the microwave energy source 11 directly to the ionized propellant in the plasma heating cavity, so as to facilitate absorption of microwave energy by the ionized propellant in the heating cavity, and so as to thereby facilitate production of a stream of heated (i.e., energized), ionized propellant. In an exemplary embodiment, the transmission of microwave energy received from the microwave energy source 11 directly to the ionized propellant in the plasma heating cavity is to be achieved while avoiding, at least partially, and preferably substantially, the absorption of microwave energy by the heater shell.

In an exemplary embodiment, to facilitate the transmission of microwave energy directly to the ionized propellant in the plasma heating cavity, substantially transmissive portions of the heater shell are disposed in positions where it is desired to transmit microwave energy directly to the stream of propellant. These substantially transmissive portions of the heater shell are configured to be substantially transparent to such transmissions of microwave energy. Put another way, the heater shell that defines the plasma heating cavity comprises one or more regions that are substantially transparent to transmissions of microwave energy. As such, the heater shell may comprise a material that is substantially transparent to transmissions of microwave energy (i.e., a microwave transmitting material), and the microwave transmitting material may be disposed in regions of the heater shell that are expected to be disposed in the path of the microwave energy beam 13 between the propellant that is passing through the plasma heating cavity and the microwave energy source 11.

In an exemplary embodiment, in addition to one or more microwave energy transmitting portions, the heater shell includes one or more microwave energy reflecting portions. The energy transmitting portions are positioned and configured so as to receive the microwave energy beam 13 and to transfer the absorbed energy to the stream of propellant in the form of thermal energy. A coating may be disposed on the energy transmitting portions so as to face in a direction toward the incipient microwave energy beam 13 (e.g., facing in an outward direction from the propellant heater 17). An insulating layer may be disposed on the energy reflecting portions so as to retain thermal energy within the propellant heater 17. It should be appreciated that the propellant heater 17 is thus configured so that the microwave energy beam 13 transmitted toward the propellant heater 17 first encounters the coating disposed on the energy transmitting portions of the propellant heater 17.

In an exemplary embodiment, the heater shell comprises a ceramic matrix composite (CMC) material configured to improve mechanical/structural strength and reliability (i.e., mechanical robustness) of the propellant heater 17. In an exemplary embodiment, the CMC material comprises structural fibers that are arranged and distributed so as to provide a propellant heater 17 that exhibits structural strength similar to that of metal with reduced weight while also providing the ability to absorb electromagnetic (microwave) energy from the microwave energy beam 13.

In an exemplary embodiment, the heater shell comprises a continuous phase (matrix) with a chemical composition that is adjusted so as to provide improved ability to selectively absorb and/or transmit microwave energy from the microwave energy beam 13. For example, in embodiments wherein the heater shell comprises a CMC material including silicon carbide fiber (distributed phase) and silicon carbide matrix, the matrix component may be doped with a quantity of dopant configured to provide suitable ability to absorb and/or transmit microwave energy from the microwave energy beam 13 considering the particular configuration of the propellant heater 17 and the particular mode of operation.

In an exemplary embodiment, the heater coating may comprise a material that is electromagnetically active (i.e., a meta-material). In such embodiments, a pattern of small (i.e., having dimensions that are typically smaller that the wavelength of the incoming electromagnetic energy) meta-material elements may be embedded into the coating deposited on the propellant heater 17. Such meta-material coatings may be configured to produce desirable electromagnetic absorption/transmission characteristics.

In an exemplary embodiment, the insulating layer is disposed so as to resist conduction of thermal energy out of the propellant heater 17. In an exemplary embodiment, the insulating layer comprises an aerogel blanket. In another exemplary embodiment, the insulating layer comprises aero-gel-filled foam, such as silicon carbide foam.

In an exemplary embodiment, the propellant heater 17 is disposed adjacent to the propellant storage tank 5. To reduce undesired transfer of thermal energy from the propellant heater 17 to the propellant storage tank 5, and/or so as to control of such transfer of heat where doing so may be desired, an insulating layer may be disposed between the propellant heater 17 and the propellant storage tank 5. In an exemplary embodiment, the insulating layer is disposed on an external surface of the propellant heater 17, the external surface being disposed adjacent to the propellant storage tank 5. Thus, the insulating layer is disposed and configured so as to prevent or reduce or otherwise regulate departure of thermal energy from the propellant heater 17 through the heater shell, and in particular, to prevent (or control the rate of) transfer of thermal energy from the propellant heater 17 to the propellant storage tank 5 or any other adjacent component of the vehicle propulsion system 3.

As shown in FIG. 1 and FIG. 2, in an exemplary embodiment, an externally powered vehicle propulsion system 3 includes a propellant accelerator 15 that is in fluid communication with an outlet of the propellant heater 17. The propellant accelerator 15 is disposed and configured for receiving a stream of heated, ionized propellant from the propellant heater 17 and for accelerating the heated ionized propellant to produce a stream of accelerated propellant. In one exemplary embodiment, as shown in FIG. 1 and FIG. 2, the propellant accelerator 15 comprises a single converging-diverging (i.e., bell) nozzle configured for accelerating the flow of propellant as it expands. It should be appreciated that the propellant accelerator 15 may comprise any mechanism known in the art for accelerating a flow of fluid, including, for example, one or more converging-diverging (bell) nozzles, one or more a converging nozzles (i.e., plug nozzles, air-spike nozzles), or a combination thereof, so as to convert stored energy (e.g., thermal energy) in the propellant (i.e., working fluid) to kinetic energy as the propellant is accelerated (e.g., expanded) in the propellant accelerator 15.

Once the propellant is accelerated, such that its momentum is suitably increased, the accelerated propellant is expelled in a desired direction so as to impose a reaction force upon the vehicle. Accordingly, thrust is generated as the heated plasma (i.e., propellant) is accelerated in the propellant accelerator 15 and discharged from the vehicle propulsion system 3.

In an exemplary embodiment, when a host vehicle 35 is in the presence of an atmosphere, such as during initial stages of the ascent) thrust produced by the system may be augmented by capturing atmospheric gas (e.g., air) and using the atmospheric gas as propellant to be accelerated via the propellant accelerator 15. For example, in exemplary air-breathing embodiments of the system, atmospheric air may be captured via an external inlet 41, which may be a supersonic inlet and/or hypersonic inlet, and subsequently mixed with the on-board propellant before being processed by the system. It should be appreciated that the subsequent processing may include introduction to the ionizer 19 or direct introduction to the propellant heater 17.

FIG. 2 shows an exemplary system comprising an external microwave source and thruster. As shown in FIG. 2, a pressure stabilization tank 23 is provided to pressurize the propellant storage tank 5. An ionizer (i.e., the plasma generator 21) is directly coupled with the source of microwave energy and serves to ionize the stream of propellant passing through the plasma generator 21. In an exemplary embodiment, external microwave energy is coupled into the flow of ionized propellant flowing through the propellant heater 17, which defines a cavity and which is substantially transparent to transmissions of microwave energy. Before entering the cavity of the propellant heater 17, propellant passes from the propellant storage tank 5 to the turbopump 7, which increases propellant's pressure and motivates the flow of pressurized propellant to the plasma generator 21. The plasma generator 21 ionizes the stream of propellant before providing it to the propellant heater 17, of which at least a portion is microwave-transparent.

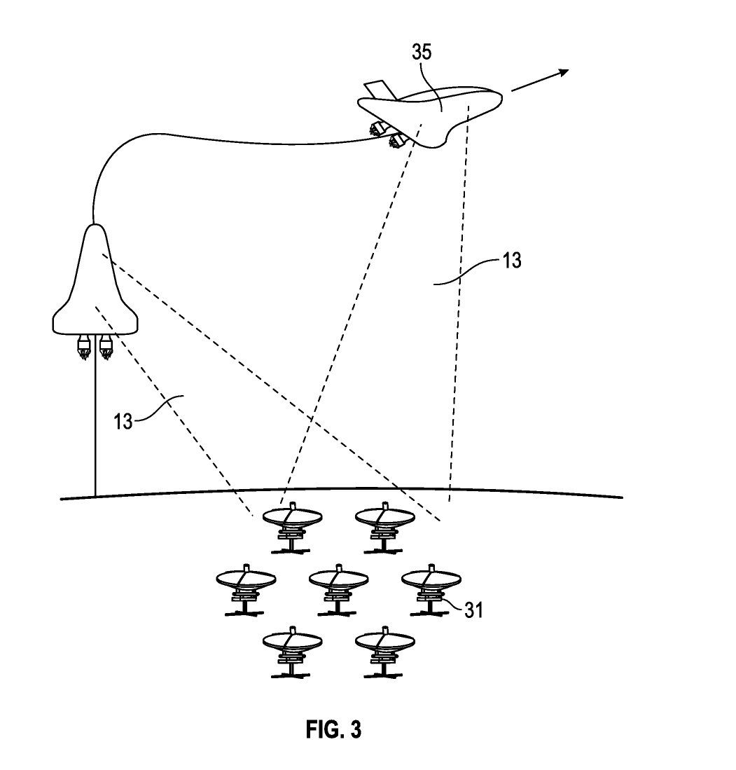

FIG. 3 is a simplified schematic diagram showing an exemplary externally powered vehicle propulsion system 3 in use to facilitate flight of a host vehicle 35. As depicted in FIG. 3, a host vehicle 35, which comprises an externally powered vehicle propulsion system 3, receives microwave energy from an external source as the host vehicle 35 follows lift-off and ascent phases of its flight trajectory. As shown in FIG. 3, a ground-based power beaming infrastructure 31, comprising a phased array of microwave antennas, is configured to serve as the source of microwave energy and to thereby provide one or more microwave energy beams 13 for reception by the host vehicle 35 during lift-off and ascent phases of its flight trajectory.

It should be appreciated that exemplary embodiments of the externally powered propulsion systems disclosed herein may be used to launch space vehicles (i.e., for space launch) or to provide propulsion at lower altitudes (i.e., for suborbital launch and atmospheric flight). Using aiming technologies as described above, the ground-based power beaming infrastructure 31 may be configured to accurately aim the microwave energy beam 13 at the host vehicle 35 (i.e., to target the host vehicle 35) and to follow the host vehicle 35 (i.e., to track the host vehicle 35) as it traverses its flight trajectory. Thus, the ground-based power beaming infrastructure 31 may be located at a position remote from the host vehicle 35, such as on the ground, on another vehicle, etc.

As described herein, the external microwave energy (i.e., microwave energy beam 13 transmitted from a microwave energy source 11 external to the vehicle propulsion system 3 and received by selected components the vehicle propulsion system 3) is used by the vehicle propulsion system 3 to ionize the propellant that is stored on-board the host vehicle 35 or otherwise accepted by the host vehicle 35 and also to heat the flow of ionized propellant as it moves through the propulsion system, to be used as a source of power by the host vehicle 35 and/or to be accelerated by the propellant accelerator 15 and exhausted from the host vehicle 35 so as to produce thrust. The microwave energy beam 13 tracks the host vehicle 35, and/or the specific portions of the host vehicle 35 as may be desired, as it accelerates to orbital or sub-orbital velocity along a desired trajectory. The system can also be used during the re-entry of the host vehicle 35 from orbit into the atmosphere, in which case the externally powered plasma thruster provides thrust for deceleration of the host vehicle 35 as it enters the atmosphere from orbit.

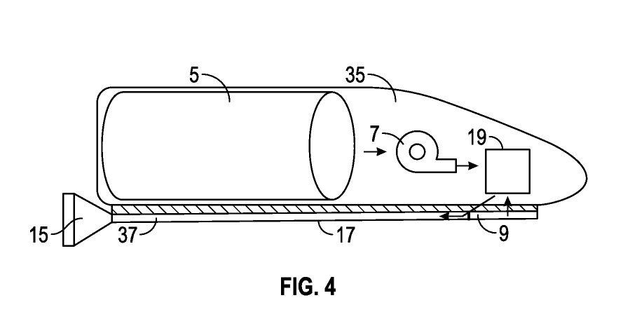

FIG. 4 is a drawing of an exemplary launch vehicle comprising an externally powered plasma thruster. As shown in FIG. 4, in an exemplary embodiment, a host vehicle 35, employing externally powered plasma propulsion, includes a propulsion system comprising a propellant storage tank 5 that provides propellant to a turbopump 7. The turbopump 7 delivers propellant to an ionizer 19 (i.e., a plasma generation chamber defined by the ionizer), in which the propellant is ionized. The ionized propellant is delivered to a propellant heater 17 containing a plasma cavity wherein microwave energy heats the ionized propellant. The propellant heater 17 (i.e., the plasma cavity) is disposed along an external surface of the host vehicle 35, and the protective insulation layer 37 is disposed between the propellant heater 17 and the adjacent structure of the host vehicle 35. The protective insulation layer 37 inhibits transfer of heat from the heater to the adjacent structure. A propellant accelerator 15, (e.g., a standard converging-diverging nozzle) accelerates the heated, ionized propellant before its discharge to the environment.

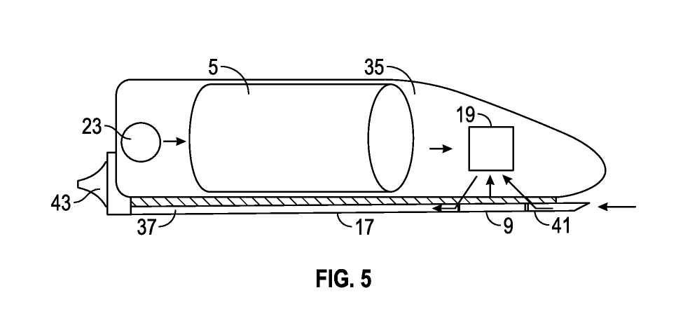

FIG. 5 is a drawing of another exemplary launch vehicle comprising an externally powered plasma thruster. As shown in FIG. 5, in an exemplary embodiment, a host vehicle 35 employs a pressure stabilization tank 23 (i.e., a pressurant tank) that pressurizes a propellant storage tank 5. The propellant storage tank 5 provides propellant directly to a plasma generation chamber (ionizer) 19 wherein the propellant is mixed with additional propellant received from a source external to the host vehicle 35 (e.g., ambient air received from the atmosphere via an external inlet 41, such as a supersonic inlet, and the combined propellant mixture is ionized. A rectifying antenna 9 is disposed for receiving beamed microwave energy and transmitting appropriate energy suitable for ionizing propellant mixture in the ionizer 19.

As shown in FIG. 5, the ionized propellant mixture is delivered to a propellant heater 17 containing a plasma cavity wherein microwave energy heats the ionized propellant. The propellant heater 17, which may also be known as a plasma cavity, is disposed along an external surface of the host vehicle 35, and the protective insulation layer 37 is disposed between the propellant heater 17 and the adjacent structure of the host vehicle 35. The protective insulation layer 37 inhibits transfer of heat from the heater to the adjacent structure. As shown in FIG. 5, in an exemplary embodiment, the propellant accelerator 15 may be configured as a plug nozzle so as to accelerate the heated, ionized propellant before its discharge to the environment.

The invention provides a novel system and method for coupling external electromagnetic energy into the thrust energy of an engine by enabling the addition of heat to a pre-ionized propellant. The addition of heat/energy is provided directly to the propellant from the incoming electromagnetic beam. This approach reduces constraints imposed by thermal properties of existing heat exchanger materials and allows higher efficiency of the engine. Accordingly a vehicle propulsion system is enabled to rely upon an external source of electromagnetic energy. In an exemplary embodiment, the system employs a beaming facility capable of focusing electromagnetic energy on a remote target, a tracking system capable of tracking a moving vehicle, and a plasma thruster capable of absorbing microwave energy and transferring part of that energy into the kinetic energy of plasma which creates thrust. The source of microwave energy for the proposed system can be a gyrotron, magnetron, relativistic magnetron, klystron, or TWT or any other microwave emitting device. Microwaves can be emitted either as a continuous wave or as a series of pulses. Beaming facility can be comprised of an array of independent microwave apertures, one singe antenna or a phased array of antennas.

The invention has been described above primarily with reference to its application in a propulsion system for a launch vehicle. It should be clear to one skilled in the art of systems for propelling vehicles, and of machines for otherwise converting energy, that systems of other varied configurations and for other uses such as generation of power or useful work can easily be envisaged and that the invention should not, and can not be limited to those examples provided herein.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. A propulsion system for a vehicle, the propulsion system comprising:
a propellant source;
an ionizer defining an ionizing chamber, the ionizer configured for receiving propellant from the propellant source into the ionizing chamber and receiving microwave energy from a microwave energy source external to the vehicle so as to ionize the propellant to produce ionized propellant;
a heater comprising a heater shell that defines a plasma heating cavity, the heater configured for receiving the ionized propellant from the ionizer into the plasma heating cavity, the heater shell configured to transmit microwave energy received from the microwave energy source to the ionized propellant in the plasma heating cavity and to thereby facilitate absorption of microwave energy by the ionized propellant in the plasma heating cavity to produce heated ionized propellant; and
a propellant accelerator for receiving the heated ionized propellant from the heater, accelerating the heated ionized propellant to produce accelerated propellant, and expelling the accelerated propellant in a desired direction to impose a reaction force upon the vehicle.

2. A propulsion system as in claim 1, wherein the microwave energy is transmitted at frequencies between approximately 500 MHz and approximately 300 GHz.

3. A propulsion system as in claim 1, wherein the microwave energy source is external to the vehicle.

4. A propulsion system as in claim 1, wherein the heater shell is substantially microwave transparent.

5. A propulsion system as in claim 1, wherein the propellant source is configured to supply propellant comprising hydrogen.

6. A propulsion system as in claim 1, wherein the propellant source is configured to supply propellant comprising an inert gas.

7. A propulsion system as in claim 1, wherein the propellant source comprises a source of propellant on-board the vehicle.

8. A propulsion system as in claim 1, wherein the propellant source comprises a source of propellant external to the vehicle.

9. A propulsion system as in claim 1, wherein the propellant source comprises a source of propellant on-board the vehicle and a source of propellant external to the vehicle.

10. A propulsion system as in claim 8, wherein the propellant source is configured to supply propellant comprising gaseous matter from outside the vehicle.

11. A propulsion system as in claim 1, wherein the ionizer comprises a rectenna.

12. A propulsion system as in claim 1, wherein the ionizer comprises a directional waveguide.

13. A method for providing a reaction force to a vehicle, the method comprising:
providing a propellant to an ionizer;
providing microwave energy to the ionizer so as to ionize the propellant in the ionizer, thereby producing ionized propellant;
transferring the ionized propellant from the ionizer to a heater;
providing microwave energy to the heater so as to transfer the microwave energy directly to the ionized propellant, thereby producing heated ionized propellant;
accelerating the heated ionized propellant, thereby producing accelerated propellant; and
expelling the accelerated propellant in a desired direction to impose a reaction force upon the vehicle.

14. A propulsion system for a vehicle, the propulsion system comprising:
a propellant source configured and arranged for providing a stream of propellant;
a heater in fluid communiocation with the propellant source, the heater comprising a heater shell that defines a plasma heating cavity, the heater configured for receiving the stream of propellant from the propellant source into the plasma heating cavity, the heater shell configured to transmit microwave energy received from a microwave energy source external to the vehicle to the stream of propellant in the plasma heating cavity and to thereby facilitate absorption of microwave energy by the stream of propellant in the plasma heating cavity to produce a stream of heated propellant; and
a propellant accelerator for receiving the stream of heated propellant from the heater, accelerating the stream of heated propellant to produce a stream of accelerated propellant, and expelling the stream of accelerated propellant in a desired direction to impose a reaction force upon the vehicle.
